(19) United States
(12) Patent Application Publication
(10) Pub. No.: US 2011/0187811 A1
(43) Pub. Date: Aug. 4, 2011

(54) APPARATUS AND METHOD FOR PROVIDING CAMERA FUNCTION IN PORTABLE TERMINAL

(75) Inventors: Moon-Soo KIM, Seoul (KR); Dae-Sung HA, Seoul (KR)

(73) Assignee: SAMSUNG ELECTRONICS CO. LTD., Suwon-si (KR)

(21) Appl. No.: 13/010,064

(22) Filed: Jan. 20, 2011

(30) Foreign Application Priority Data
Jan. 29, 2010 (KR) 10-2010-0008646

(51) Int. Cl. H04N 7/14; H04N 5/225; H04N 5/228; H04N 5/76

(52) U.S. Cl. 348/14.01; 348/207.99; 348/222.1; 348/231.99; 348/E07.077; 348/E05.024; 348/E05.031

(57) ABSTRACT

An apparatus and a method for capturing an image in a portable terminal are provided. More particularly, an apparatus and a method for capturing an image by using an action of a user as a command for photographing an object so as to prevent a shaking problem which can occur during image capturing using a portable terminal are provided. The apparatus includes an image obtainer for using an action of a user as a command to capture an image.

### PRIORITY

This application claims the benefit under 35 U.S.C. §119(a) of a Korean patent application filed in the Korean Intellectual Property Office on Jan. 29, 2010, and assigned Serial No. 10-2010-0008646, the entire disclosure of which is hereby incorporated by reference.

### BACKGROUND OF THE INVENTION

1. Field of the Invention

The present invention relates to an apparatus and a method for capturing an image in a portable terminal. More particularly, the present invention relates to an apparatus and a method for capturing an image using an action of a user as a command for photographing an object so as to prevent the capturing of a poor image due to shaking of the portable terminal.

2. Description of the Related Art

Portable terminals are used as a medium for wireless voice communication and information exchange. With the convenience provided by these functions, the use of portable terminals has grown rapidly such that the portable terminal has become an effective necessity in modern life.

When it was first introduced, the portable terminal provided the features of portability and wireless communication. As technology has advanced, service providers and portable terminal manufacturers are competitively developing products and services to distinguish themselves from others.

For example, advanced portable terminals are now provided as multimedia devices and support such functions as a phonebook, games, a Short Message Service (SMS), Electronic (E)-mail, morning calls, a Motion Picture Expert Group (MPEG)-1 or MPEG-2 Audio Layer-3 (MP3) player, a schedule management function, a digital camera, and a wireless Internet service, and thus provides diverse services.

The digital camera function, which is a frequently used function of a portable terminal, is able to capture a high quality image so that the user no longer needs to carry a separate camera.

To use the digital camera function, the user of the portable terminal needs to confirm an image of the object and then input a shutter command for capturing the object.

However, when the input is provided for the shutter command, the user's hand may shake or otherwise cause the focus of the captured image to be lost. Thus, the captured image may appear blurry or otherwise out of focus due to the shaking of the portable terminal.

To address this problem, a hand shake prevention function or a timer function may be provided which automatically captures the image after a certain time.

However, such functions are not adopted in all portable terminals. Thus, a portable terminal not supporting those functions has difficulty in avoiding the blurring of the captured image and an improved apparatus and method for enhancing an image capturing function of a portable terminal is needed.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for enhancing an image capturing performance of a portable terminal.

Another aspect of the present invention is to provide an apparatus and a method for providing a shake compensation function which photographs an object by recognizing an action of a user of a portable terminal.

Yet another aspect of the present invention is to provide an apparatus and a method for recognizing an action which controls a main camera, through a sub-camera in a portable terminal.

Still another aspect of the present invention is to provide an apparatus and a method for recognizing an action of a user authorized to capture an image in a portable terminal.

In accordance with an aspect of the present invention, an apparatus for capturing an image in a portable terminal is provided. The apparatus includes an image obtainer for using an action of a user as a command to capture an image.

In accordance with another aspect of the present invention, a method for capturing an image in a portable terminal is provided. The method includes using an action of a user as a command to capture an image.

In accordance with yet another aspect of the present invention, an apparatus for capturing an image in a portable terminal is provided. The apparatus includes a first camera for photographing an object, a second camera for photographing an action of a user, a display unit for outputting the object captured by the first camera, a memory unit for storing action information of a user to photograph the object, an image obtainer for using an action of the user as a command to capture an image, and a controller for controlling to photograph the object captured through the first camera using the action of the user captured through the second camera.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable terminal for providing an object photographing function with shake compensation according to an exemplary embodiment of the present invention;

FIG. 2 is a flowchart of a method for photographing an object using a portable terminal according to an exemplary embodiment of the present invention;

FIG. 3 is a flowchart of a method for capturing an image in a portable terminal according to an exemplary embodiment of the present invention;

FIG. 4A is a diagram of a portable terminal and a setting of the portable terminal according to an exemplary embodiment of the present invention;

FIG. 4B is a diagram of a photographing success through an action in a portable terminal according to an exemplary embodiment of the present invention; and

FIG. 4C is a diagram of a photographing denial through an action in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for enhancing an image capturing performance by providing a shake compensation function which recognizes a user's action (e.g., facial expression, hand movement of the user, and the like) and thus photographs an object in a portable terminal.

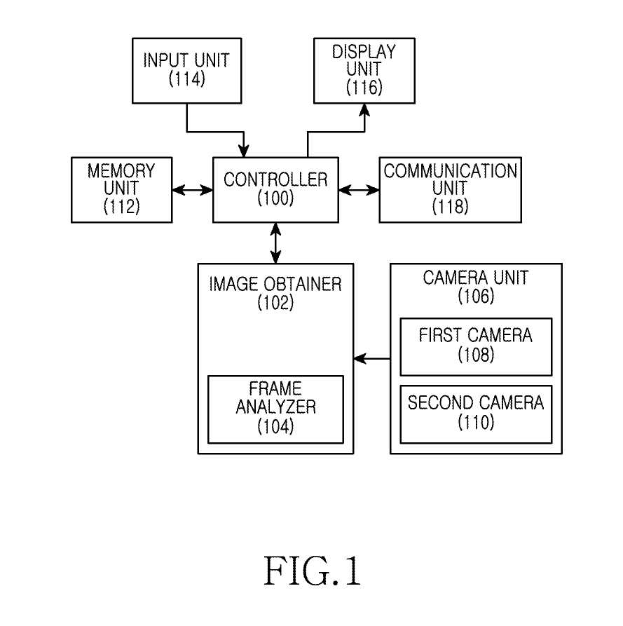

FIG. 1 is a block diagram of a portable terminal for providing an object photographing function with shake compensation according to an exemplary embodiment of the present invention.

Referring to FIG. 1, a portable terminal may include a controller 100, an image obtainer 102, a camera unit 106, a memory unit 112, an input unit 114, a display unit 116, and a communication unit 118. The image obtainer 102 may further include a frame analyzer 104. The camera unit 106 may be implemented using a plurality of cameras (a first camera 108 and a second camera 110). The portable terminal may include additional units that are not illustrated here merely for sake of clarity. Similarly, the functionality of two or more of the above units may be integrated into a single component.

The controller 100 controls operations of the portable terminal. For example, the controller 100 processes and controls voice communication and data communication. In addition to these typical functions, the controller 100 processes to prevent the blurring of a captured image due to improper focus caused by shaking during the image capturing process.

For doing so, the controller 100 detects a user's action and determines if the action is for photographing an object. That is, the controller 100 detects the user's action and determines if the detected action is a predetermined action that is used as a substitute for the pressing of a shutter control button.

More specifically, the controller 100 determines the user's action by analyzing a frame input through the second camera 110. When it is determined that the analyzed action corresponds to an action for controlling the first camera 108 (i.e., for controlling the first camera 108 to photograph an object), the controller 100 processes to photograph and store the object (the image) captured by the first camera 108.

In an exemplary implementation, the controller 100 also analyzes the frame input through the second camera 110 and processes to control the first camera 108 only when it matches pre-stored user information, to thus enhance security of the image capturing.

The image obtainer 102 processes to obtain the image with the blur compensated under the control of the controller 100.

In more detail, the image obtainer 102 recognizes the action for controlling the first camera 108 by analyzing the frame input through the second camera 110, and may also determine whether the user acting to control the first camera 108 is a user authorized to capture the image.

The image obtainer 102 recognizing the action and/or the authorized user processes to capture and store the image input through the first camera 108.

The frame analyzer 104 of the image obtainer 102 analyzes the frame input through the second camera 110 and determines the user's action and whether the user is the user authorized to capture the image under the control of the image obtainer 102.

The camera unit 106, which is a camera module for photographing an object, includes the first camera 108 functioning as a digital camera and the second camera 110 for capturing the user's action. The second camera 110 can be a camera for video telephony.

The memory unit 112 includes at least one of a Read Only Memory (ROM), a Random Access Memory (RAM), a flash ROM, and the like. The ROM stores microcodes and reference data of a program for processing and controlling the controller 100 and the image obtainer 102.

The RAM, which is a working memory of the controller 100, stores temporary data generated during the program execution. The flash ROM contains updatable data such as phonebook information, outgoing messages, incoming messages, and the like. In an exemplary embodiment of the present invention, the flash ROM contains user's action information for photographing the object.

The input unit 114 includes a plurality of function keys such as number keys 0˜9, a menu key, a cancel key, an OK key, a call key, an end key, an Internet access key, navigation keys, character input keys, and the like. The input unit 114 provides the controller 100 with key input data corresponding to the key pressed by the user.

The display unit 116 displays status information, characters, videos, and still images during the operation of the portable terminal. The display unit 116 can employ a color Liquid Crystal Display (LCD). When the display unit 116 includes a touch input device and is applied to a touch-type portable terminal, it can be used as the input device.

The communication unit 118 processes to transmit and receive radio signals of data input and output via an antenna (not illustrated). For instance, in the transmission, the communication unit 118 channel-encodes, spreads, Radio Frequency (RF)-processes, and transmits data. In the reception, the communication unit 118 converts the received RF signal into a baseband signal and restores the data by de-spreading and channel-decoding the baseband signal.

While the controller 100 of the portable terminal can serve as the image obtainer 102, they are separately illustrated here to distinguish various exemplary functions of the present invention, not to limit the scope of the invention. One skilled in the art should understand that various modifications can be made without departing from the spirit and scope of the invention. For example, the controller 100 can process all of the functions of the image obtainer 102.

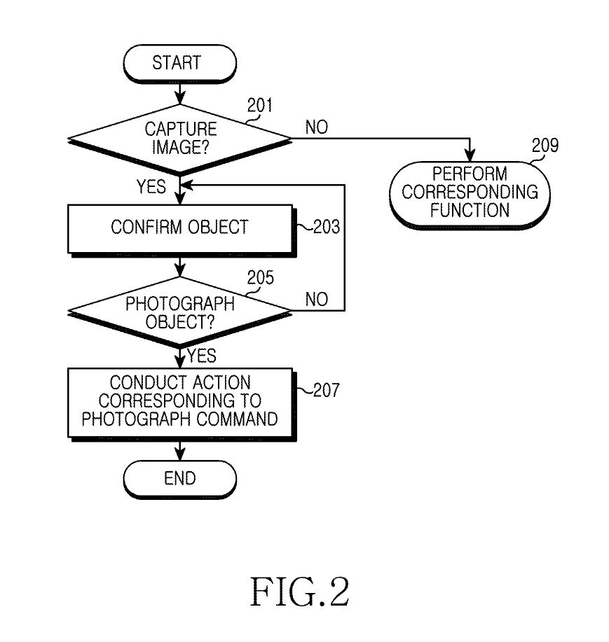

FIG. 2 is a flowchart of a method for photographing an object using a portable terminal according to an exemplary embodiment of the present invention.

In step 201, the portable terminal determines if an image is to be captured by operating in a camera mode. For example, it may be determined in step 201 whether a user executes an image capturing function of the portable terminal.

If it is determined in step 201 that an image is not to be captured, the portable terminal executes a corresponding function (e.g., a standby mode) in step 209.

On the other hand, if it is determined in step 201 that an image is to be captured, the user of the portable terminal verifies the object captured by the camera, for example by viewing an image of the object output on an LCD screen, in step 203, and then determines whether to photograph the object in step 205.

If it is determined in step 205 not to photograph the object, the portable terminal returns to step 203 and again determines an object to photograph.

On the other hand, if it is determined in step 205 to photograph the object, the user of the portable terminal performs the action (e.g., an eye blink, a hand gesture “V”, etc.) corresponding to the photograph command in step 207.

That is, according to an exemplary implementation, the portable terminal determines that the shutter control is input by detecting the user action without the need for the user to input a shutter command using a key or button.

For instance, the portable terminal operates the first camera for photographing the object and the second camera for photographing the user. Upon detecting the action of the user through the second camera, the portable terminal can process to capture the image input to the first camera. By performing the action and capturing the image using the portable terminal without the need for the user to press a shutter key, an in-focus image, that is an image without blurring, can be acquired without using a separate hand shake prevention function.

Next, the portable terminal finishes this process.

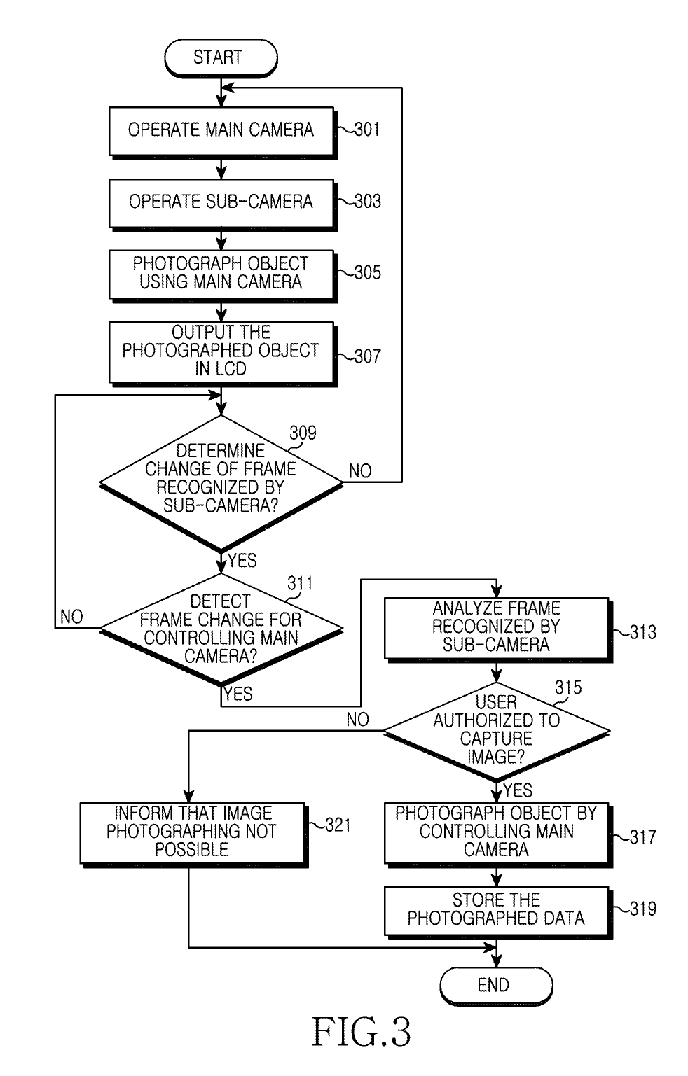

FIG. 3 is a flowchart of a method for capturing an image in a portable terminal according to an exemplary embodiment of the present invention.

In an exemplary implementation, the portable terminal includes a main camera for serving as a digital camera and a sub-camera for video telephony. The portable terminal recognizes a user's action via the sub-camera and controls the main camera based on the action recognized by the sub-camera.

For doing so, the portable terminal operates the main camera in step 301 and then operates the sub-camera in step 303.

After capturing an object using the main camera in step 305, the portable terminal controls to output an image of the object captured using the main camera to an LCD or other display device of the portable terminal in step 307.

In step 309, the portable terminal determines whether the frame captured by the sub-camera is changed. For example, the portable terminal determines if there is a change from one frame captured by the sub-camera to another frame captured by the sub-camera in order to examine the action of the user.

If it is determined in step 309 that there is no change of the frame captured by the sub-camera, the portable terminal returns to step 301 and repeats the subsequent steps.

In contrast, upon determining in step 309 that there is a change of the frame captured by the sub-camera, the portable terminal analyzes the frame change and proceeds to step 311 to determine whether the frame change is for controlling the main camera.

For example, assuming that the user's eye blink action is established as the command for controlling the main camera, the portable terminal determines whether the user's eye blinks by analyzing frames of the user captured by the sub-camera and examining if the images of the frames change from having an opened eye to a closed eye.

If it is determined in step 311 that there is no frame change for controlling the main camera based on the examination of the frames, the portable terminal returns to step 309 to again determine whether the frame captured by the sub-camera is changed.

On the other hand, upon determining in step 311 that there is a frame change for controlling the main camera based on the examination of the frames, the portable terminal can control the main camera to photograph the object.

In a further exemplary implementation as illustrated in FIG. 3, the recognizing of the action of the user by the portable terminal can be enhanced to also provide a security measure.

That is, when recognizing the action of the user, the portable terminal may also determine whether the user that inputs the action is authorized to capture the image by further analyzing a frame captured by the sub-camera in step 313. Based on the frame analysis of step 313, the portable terminal determines in step 315 whether the user is authorized to capture an image.

If it is determined in step 315 that the user is not authorized to capture the image, the portable terminal outputs a message informing that the capturing of the image is not possible in step 321 and then finishes this process.

On the other hand, upon determining in step 315 that the user is authorized to capture the image, the portable terminal photographs the object by controlling the main camera in step 317 and stores the photographed data in step 319.

As stated earlier, the portable terminal recognizes the user's action by analyzing the frames captured by the sub-camera, and controls the main camera when the action is recognized. In so doing, the portable terminal can also enhance the security by capturing the image only when determining that the user is authorized to capture the image after recognizing the action.

Next, the portable terminal finishes this process.

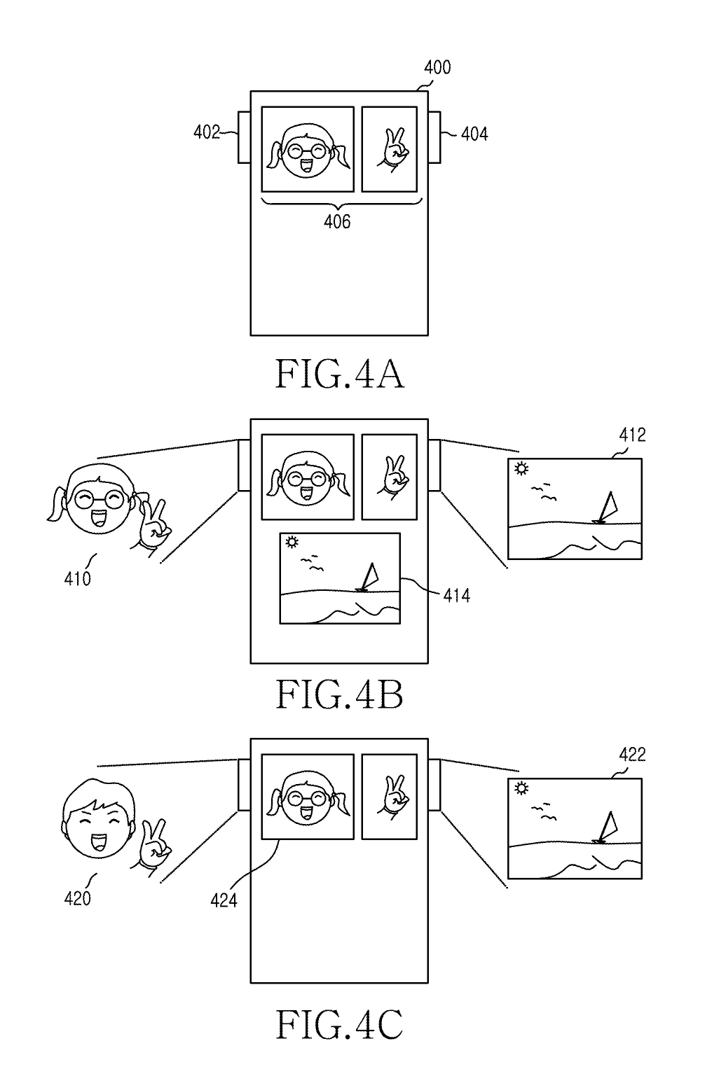

FIGS. 4A-4C depict an image capturing process of a portable terminal according to an exemplary embodiment of the present invention.

FIG. 4A is a diagram of a portable terminal and a setting of the portable terminal according to an exemplary embodiment of the present invention.

Referring to FIG. 4A, the portable terminal 400 includes two cameras, which are a main camera 404 that serves as the general digital camera and a sub-camera 402 for performing the video telephony. The portable terminal 400 controls the main camera 404 by recognizing a user's action using the sub-camera 402. In an exemplary implementation, the main camera 404 may be placed on a first side of the portable terminal and the sub-camera 402 may be placed on a second side of the portable terminal that is opposite the first side.

As illustrated at 406, the portable terminal 400 stores information regarding the user's action for controlling the main camera 404 and information of a user or user's that are authorized to capture an image. While only one authorized user is illustrated in FIG. 4A, it is to be understood that this is merely for convenience and that any number of users may be authorized.

When capturing the image using the portable terminal 400 configured as above, the portable terminal 400 recognizes the user's action by analyzing one or more frames captured by the sub-camera 402.

More specifically, upon recognizing the user's action by analyzing the one or more frames captured by the sub-camera 402, the portable terminal 400 controls the main camera 404 to photograph the input object.

Alternatively, the portable terminal 400 may determine whether a user authorized to capture an image is present in a frame captured by the sub-camera and thus allow only an authorized user to capture the image.

FIG. 4B is a diagram of a photographing success through an action in a portable terminal according to an exemplary embodiment of the present invention.

Referring to FIG. 4B, it is assumed that the user's action for controlling the main camera is the hand gesture “V” and that the portable terminal contains the information of a user authorized to capture an image as described above and illustrated at 406 in FIG. 4A.

As discussed above, when a user of a portable terminal presses a shutter button to photograph on image using a main camera of the portable terminal, a shaking of the portable terminal may blur the image.

To address this problem, the portable terminal according to an exemplary embodiment of the present invention controls the main camera by recognizing the user's action with the sub-camera.

In the illustrated example of FIG. 4B, upon recognizing the hand gesture “V” of the user 410 by analyzing one or more frames captured by the sub-camera, the portable terminal processes to photograph and store the sea view 412 recognized by the main camera as illustrated at 414.

Furthermore, the portable terminal may determine whether the user 410 in the frame captured by the sub-camera is a user authorized to capture images and thus prevents the main camera from being controlled by the hand gesture “V” of an unauthorized user.

For instance, when the portable terminal recognizes the user's action as an action for controlling the main camera, the portable terminal photographs and stores the object input through the main camera when the frame captured by the sub-camera includes an authorized user.

FIG. 4C depicts a photographing denial through an action in a portable terminal according to an exemplary embodiment of the present invention.

Referring to FIG. 4C, it is assumed that the user's action for controlling the main camera is the hand gesture “V” and that the portable terminal contains information of one or more users that are authorized to capture images as described above with reference to FIG. 4A.

If the security measures are not in effect, when analyzing one or more frames captured by the sub-camera and recognizing the hand gesture “V” of the user 420, the portable terminal processes to photograph and store the sea view 422 recognized by the main camera.

However, if the security measures are in effect, the portable terminal determines whether a frame captured by the sub-camera includes an authorized user 424 and thus prevents the main camera from being controlled by the hand gesture “V” of an unauthorized user.

As such, the portable terminal analyzes frames input through the sub-camera and thus determines if the user's action corresponds to an action that is preset for controlling the main camera and if the information of the user corresponds to information regarding users that are authorized to capture the image.

When there is no authorized user in the frame input through the sub-camera or the user's action for controlling the main camera is not recognized, the portable terminal does not control the main camera. For example, even when the user's action for controlling the main camera is recognized but the frame input through the sub-camera does not include an authorized user, the portable terminal does not photograph the object input through the main camera.

As set forth above, to prevent the hand shake problem in the image capturing of the portable terminal, a user's action is used as the command for photographing the object, instead of the shutter input. Therefore, it is possible to address the shaking problem in the image capturing through the shutter input in the conventional portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for capturing an image in a portable terminal, the apparatus comprising:
an image obtainer for using an action of a user as a command to capture an image.

2. The apparatus of claim 1, wherein, when a main camera and a sub-camera are operated and the sub-camera detects an action corresponding to the command to capture the image, the image obtainer photographs an object using the main camera.

3. The apparatus of claim 2, wherein the image obtainer detects the command to capture the image by analyzing one or more frames input through the sub-camera.

4. The apparatus of claim 2, wherein the image obtainer determines whether an image of a user input through the sub-camera corresponds to a user authorized to capture the image, and detects only the action of the authorized user as the command to capture the image.

5. The apparatus of claim 2, wherein the main camera comprises a camera for photographing the object, and the sub-camera comprises a camera for performing video telephony.

6. A method for capturing an image in a portable terminal, the method comprising:
using an action of a user as a command to capture an image.

7. The method of claim 6, further comprising:
operating a main camera and a sub-camera; and
when detecting an action corresponding to the command to capture the image through the sub-camera, photographing an object using the main camera.

8. The method of claim 7, wherein the action corresponding to the command to capture the image is detected by analyzing one or more frames input through the sub-camera.

9. The method of claim 7, further comprising:
when detecting the action corresponding to the command to capture the image through the sub-camera, determining whether an image of a user input through the sub-camera corresponds to a user authorized to capture the image; and
detecting only the action of the authorized user as the command to capture the image.

10. The method of claim 7, wherein the main camera comprises a camera for photographing the object, and the sub-camera comprises a camera for performing video telephony.

11. An apparatus for capturing an image in a portable terminal, the apparatus comprising:
a first camera for photographing an object;
a second camera for photographing an action of a user;
a display unit for outputting the object captured by the first camera;
a memory unit for storing action information of the user to photograph the object;
an image obtainer for using an action of the user as a command to capture an image; and
a controller for controlling to photograph the object captured through the first camera using the action of the user captured through the second camera.

12. The apparatus of claim 11, wherein the image obtainer detects the command to capture the image by analyzing one or more frames input through the second camera.

13. The apparatus of claim 11, wherein the image obtainer determines whether an image of the user input through the sub-camera corresponds to a user authorized to capture the image, and detects only the action of the authorized user as the command to capture the image.

14. The apparatus of claim 11, wherein the second camera comprises a camera for video telephony.

15. A method for capturing an image in a portable terminal, the method comprising:
detecting an action of a user using one or more captured images; and
determining if the detected action corresponds to a command to capture an image.

16. The method of claim 15, further comprising:
if it is determined that the detected action corresponds to the command to capture the image, capturing the image with a first camera,
wherein the detecting of the action of the user using one or more captured images comprises capturing the one or more captured images by a second camera.

17. The method of claim 15, further comprising:
if it is determined that the detected action corresponds to the command to capture the image, determining whether an image of a user input through the second camera corresponds to a user authorized to capture the image; and
if it is determined that the image of the user input through the second camera corresponds to the user authorized to capture the image, capturing the image with the first camera.
